(19) United States
(12) Patent Application Publication
(10) Pub. No.: US 2001/0012434 A1
(43) Pub. Date: Aug. 9, 2001

(54) Optical attenuator, optical photometer and method for controlling quantity of light

(76) Inventor: Yoshinori Satoh, Tokyo (JP)

Correspondence Address: Pillsbury Madison & Sutro LLP, Intellectual Property Group, East Tower, Ninth Floor, 1100 New York Avenue, N.W., Washington, DC, 20005-3918, US

(21) Appl. No.: 09/770,240

(22) Filed: Jan. 29, 2001

(30) Foreign Application Priority Data
Jan. 28, 2000 (JP) 2000-20488

(51) Int. Cl. G02B 6/38

(52) U.S. Cl. 385/140; 385/70

(57) ABSTRACT

An optical attenuator realizable at a lower cost, for easily attenuating a quantity of light transmitted through an optical fiber, an optical photometer using the optical attenuator and a method for controlling a quantity of light by the optical attenuator. The optical attenuator (10, 11) comprises: two ferrules (41, 42) provided so that top surfaces thereof are stood opposite to each other, in which an optical fiber (31, 32) is connected to a base edge portion on each of the ferrules and either or both of the ferrules can be moved along an optical axis of each ferrule; and a split sleeve (2) for holding the ferrules in the same axis line (X, Y).

### BACKGROUND OF THE INVENTION

1. Field of the Invention

The present invention relates to an optical attenuator for attenuating a quantity of light transmitted through an optical fiber, an optical photometer using the optical attenuator and a method for controlling a quantity of light by the optical attenuator.

2. Description of Related Art

In order to measure a quantity of light transmitted through an optical fiber, an optical photometer apparatus, for example, in a heterodyne detection system is used.

As an example of the optical photometer apparatus in the heterodyne detection system, an optical photometer 100 is shown in FIG. 4.

The optical photometer 100 shown in FIG. 4 comprises a double balanced receiver for measuring a quantity of light distributed by an optical coupler 5, by two photo-reception modules 6, respectively. According to each photo-reception module 6, when the light transmitted through an optical fiber 3 is inputted from a ferrule 63, the light inputted from the ferrule 63 is condensed to a photo-reception surface of a photo-reception element 61 by a lens part 62. Accordingly, a detection current is outputted from the photo-reception element 61, according to the quantity of light received by the photo-reception surface of the photo-reception element 61.

Preferably, according to the double balanced receiver of the optical photometer 100, the detection current outputted from one photo-reception element 61 is the same as one from the other photo-reception element 61. However, some effects of the dispersion of the distribution ratio of the optical coupler 5, the individual difference in the sensitivity of the photo-reception element 61 and so on can not be ignored. Accordingly, the optical photometer 100 is controlled when it is manufactured.

For example, a method shown in FIG. 5A, for controlling a quantity of light has been known, wherein a tunable optical attenuator 7 for attenuating a quantity of light by a predetermined return loss is provided between the optical coupler 5 (shown in FIG. 4) and the input terminal side of the photo-reception module 6 (shown in FIG. 4).

The input light to be inputted to either photo-reception element 61 is attenuated by the tunable optical attenuator 7, and thereby the detection currents outputted two photo-reception modules 6 have been controlled so as to be equal to each other.

Further, another method shown in FIG. 5B, for attenuating a quantity of light has been known, wherein the optical fiber 3 is bended so as to form a micro bending 3a between the optical coupler 5 and the photo-reception module 6.

The radius of the micro bending 3a is shorted so as to be not negligible with regard to the wavelength of light transmitted through the micro bending 3a, and thereby the enough return loss to control the quantity of light is generated and the input light to be inputted to the photo-reception module 6 is controlled.

However, according to the method shown in FIG. 5A, it is necessary that the return loss is controlled in consideration of the return loss generated by inserting the tunable optical attenuator 7 into the optical photometer 100. As a result, a problem of doing a complex work requiring taking a lot of time has occurred. Further, the tunable optical attenuator 7 is expensive, so that another problem of increasing a cost has occurred.

Further, according to the method shown in FIG. 5B, it often happens that the radius of the micro bending 3a is shorter than the minimum radius capable of bending the optical fiber 3. As a result, a further problem of losing the reliability of the optical fiber 3 has occurred.

### SUMMARY OF THE INVENTION

The present invention was developed in view of the above-described problems.

An object of the present invention is to provide an optical attenuator realizable at a lower cost, for easily attenuating a quantity of light transmitted through an optical fiber, an optical photometer using the optical attenuator and a method for controlling a quantity of light by the optical attenuator.

In accordance with one aspect of the present invention, an optical attenuator (for example, an optical attenuator 10 shown in FIG. 1A and an optical attenuator 11 shown in FIG. 3) comprises: two ferrules (for example, ferrules 41 shown in FIG. 1A and ferrules 42 shown in FIG. 3) provided so that top surfaces thereof are stood opposite to each other, in which an optical fiber (for example, an input side optical fiber 31 and an output side optical fiber 32 shown in FIG. 1A and FIG. 3) is connected to a base edge portion on each of the ferrules and either or both of the ferrules can be moved along an optical axis of each ferrule; and a split sleeve (for example, a split sleeve 2 shown in FIG. 1A and FIG. 3) for holding the ferrules in the same axis line (for example, a line X shown in FIG. 1A and a line Y shown in FIG. 3).

According to the optical attenuator as described above, a light inputted to the optical attenuator is transmitted through the top surface of one ferrule and the top surface of the other ferrule. Herein, either or both of the ferrules are moved along the optical axis, thereby a gap is generated between the top surfaces of the ferrules. Therefore, the light inputted to the optical attenuator is transmitted through the top surfaces of the ferrules and the gap generated between the top surfaces, so that the light is attenuated.

Accordingly, the gap is generated between the top surfaces of the ferrules, by moving the ferrules, and thereby the light is attenuated. Consequently, it is possible to attenuate a quantity of light by an easy operation.

Further, a return loss of light is changed according to the distance of the gap generated between the ferrules. Consequently, it is possible to minutely control the return loss of light by changing the distance of the gap between the ferrules, as the occasion may demand.

And further, the optical attenuator has a very simple structure, so that it is possible to provide the optical attenuator at a low cost.

Preferably, according to the optical attenuator as described above, the top surface (for example, the top surfaces at an optical contact portion C shown in FIG. 3) on each of the ferrules is formed so as to slant against the optical axis of each ferrule.

According to the optical attenuator as described above, the top surface of the ferrule is slanted against the optical axis of the ferrule, so that the reflection loss caused by the reflection of the light when the light passes through the top surface of the ferrule, is smaller than one in the case that the top surface of the ferrule is vertical against the optical axis of the ferrule. Consequently, it is possible to realize a big return loss by the optical attenuator having a simple structure and requiring a low manufacturing cost.

In accordance with another aspect of the present invention, an optical photometer (for example, an optical photometer 1 shown in FIG. 2) comprises: an optical coupler (for example, an optical coupler 5 shown in FIG. 2) for distributing a light inputted from an outside to a plurality of coupler output optical fibers (for example, coupler output optical fibers 34), to output a distributed light to each of the coupler output optical fibers; a plurality of optical attenuators (for example, optical attenuators 10 shown in FIG. 2) connected to the optical coupler through the coupler output optical fibers respectively, in which each of the optical attenuators attenuates the distributed light by a predetermined return loss, to output an attenuated light to each of a plurality of attenuation output optical fibers (for example, attenuation output optical fibers 35 shown in FIG. 2); and a plurality of detection members (for example, photo-reception modules 6 shown in FIG. 2) connected to the optical attenuators through the attenuation output optical fibers respectively, in which each of the detection members detects a quantity of the attenuated light; wherein each of the optical attenuators comprises: two ferrules provided so that top surfaces thereof are stood opposite to each other, in which an optical fiber is connected to a base edge portion on each of the ferrules and either or both of the ferrules can be moved along an optical axis of each ferrule; and a split sleeve for holding the ferrules in the same axis line.

According to the optical photometer as described above, the optical coupler distributes the light inputted from the outside, the optical attenuator attenuates the distributed light, and the detection member detects the attenuated light.

Further, according to the optical attenuator, the light is transmitted through the top surface of one ferrule and the top surface of the other ferrule. Either or both of the ferrules are moved along the optical axis, thereby a gap is generated between the top surfaces of the ferrules. Therefore, the light inputted to the optical attenuator is transmitted through the top surfaces of the ferrules and the gap generated between the top surfaces, so that the light is attenuated.

Consequently, the ferrules are moved, thereby the light is attenuated, so that it is possible to efficiently attenuate a quantity of light by an easy operation. Further, it is possible to minutely control a return loss of light easily, by changing the distance of the gap between the ferrules.

That is, according to the optical photometer as described above, it is possible to attenuate the light inputted to the detection member by the predetermined return loss. Consequently, it is possible to easily control the return loss of light by each optical attenuator, when the difference between the results of detecting the quantity of the attenuated light by a plurality of detection members is caused by the dispersion of the distribution ratio of the optical coupler and the difference in the sensitivity of such a device which each detection member comprises as a photo diode, a photo transistor and so on.

Further, the optical photometer has a simple structure, so that it is possible to realize the optical photometer at a low cost. Consequently, it is possible to prevent the manufacturing cost of the optical photometer from increasing.

Preferably, according to the optical photometer as described above, the top surface on each of the ferrules is formed so as to slant against the optical axis of each ferrule.

According to the optical photometer as described above, the top surface of the ferrule is slanted against the optical axis of the ferrule, so that the reflection loss caused by the reflection of the light when the light passes through the top surface of the ferrule, is smaller than one in the case that the top surface of the ferrule is vertical against the optical axis of the ferrule. Consequently, it is possible to realize a big return loss by the optical attenuator. As a result, it is possible to easily control the return loss of light efficiently, when the difference is generated between the results of detecting the quantity of the attenuated light by a plurality of detection members, and it is possible to reduce such an effect on the optical system as an interference and so on, by the big return loss.

Preferably, according to the optical photometer as described above, each of the detection members (for example, a photo-reception module 6 shown in FIG. 2) comprises: a ferrule (for example, a ferrule 63 shown in FIG. 2) to which the attenuated light is inputted from the attenuation output optical fiber; a lens part (for example, a lens part 62 shown in FIG. 2) through which the attenuated light inputted to the ferrule is condensed; and a photo-reception element (for example, a photo-reception element 61 shown in FIG. 2) for outputting a detection current according to the attenuated light condensed through the lens part.

In accordance with a further object of the present invention, in a method for controlling a quantity of light, by an optical attenuator, the optical attenuator comprising: two ferrules provided so that top surfaces thereof are stood opposite to each other, in which an optical fiber is connected to a base edge portion on each of the ferrules; and a split sleeve for holding the ferrules in the same axis line; the method comprises the step of moving either or both of the ferrules along an optical axis of each ferrule.

According to the method as described above, either or both of the ferrules are moved along the optical axis, thereby a gap is generated between the top surfaces of the ferrules. Therefore, when the light is transmitted through the gap, the light is attenuated.

Accordingly, the gap is generated between the top surfaces of the ferrules, by moving the ferrules, and thereby the light is attenuated. Consequently, it is possible to efficiently attenuate a quantity of light by an easy operation. Further, the distance of moving the ferrules is changed, and thereby the distance of the gap between the ferrules is controlled. Consequently, it is possible to minutely control the quantity of the return loss of light, as the occasion may demand.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein:

FIGS. 1A and 1B are views showing a structure of an optical attenuator 10 according to a first embodiment of the present invention;

FIG. 2 is a view showing a structure of an optical photometer 1 according to a second embodiment of the present invention;

FIG. 3 is a view showing a structure of an optical attenuator 11 according to a third embodiment of the present invention;

FIG. 4 is a view showing a structure of an optical photometer 100 according to an earlier development; and

FIGS. 5A and 5B are views showing a example of a method for controlling a quantity of light by the optical photometer 100 according to an earlier development.

### PREFERRED EMBODIMENT OF THE INVENTION

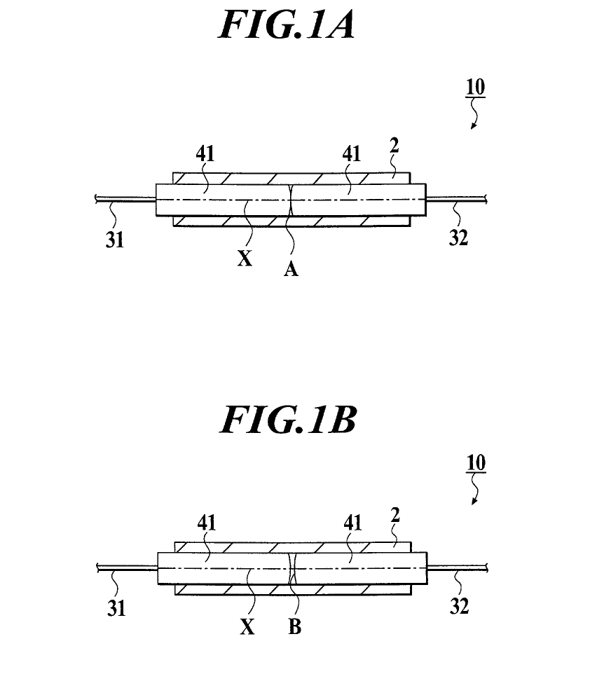

Hereinafter, an embodiment of the optical attenuator and the optical photometer of the present invention will be explained with reference to FIGS. 1 to 3, in detail.

[First embodiment of the invention]

First, as the first embodiment of the present invention, an optical attenuator 10 will be explained with reference to FIGS. 1A and 1B, as follows.

FIGS. 1A and 1B are views showing a structure of the optical attenuator 10. FIG. 1A shows a state in which a quantity of light is not attenuated, and FIG. 1B shows a state in which a quantity of light can be attenuated. In FIGS. 1A and 1B, the reference numeral 2 denotes a split sleeve, the reference numeral 31 denotes an input side optical fiber, the reference numeral 32 denotes an output side optical fiber and the reference numeral 41 denotes a ferrule.

As shown in FIG. 1A, according to the optical attenuator 10, two ferrules 41 are held in an inside of the split sleeve 2.

The input side optical fiber 31 is connected to a base edge portion of one ferrule 41. The output side optical fiber 32 is connected to a base edge portion of the other ferrule 41. Two ferrules 41 are provided so that the top surfaces thereof are stood opposite to each other, and held in the same axis line in the inside of the sleeve 2.

Accordingly, cores of the input side optical fiber 31 and the output side optical fiber 32 agree with the optical axis of the ferrule 41, on the line shown by the reference character X in FIG. 1A.

In the state shown in FIG. 1A, the top surfaces of two ferrules 41 are contacted with each other at an optical contact portion shown by the reference character A. Accordingly, when the light inputted from the input side optical fiber 31 passes through the optical attenuator 10, a reflection loss is generated on the top surface of each ferrule 41.

On the other hand, either or both ferrules 41 are moved along the optical axis of the ferrule 41 so that the top surfaces of two ferrules 41 are separated from each other in the state shown in FIG. 1A, thereby the ferrules 41 are in the state shown in FIG. 1B.

In the state shown in FIG. 1B, a gap is generated at an optical contact portion shown by the reference character B in FIG. 1B. The light inputted from the input side optical fiber 31 to the optical attenuator 10 is transmitted through air at the optical contact portion B, and after the light is outputted from the output side optical fiber 32. As a result, a larger loss is generated at the optical contact portion B in FIG. 1B, than the reflection loss generated at the optical contact portion A in FIG. 1A.

Further, the loss is changed according to the distance of the gap at the optical contact portion B. Accordingly, the distance of the gap is changed as the occasion may demand, by moving the ferrules 41, and thereby it is possible to control the return loss as the occasion may demand. Further, the distance of the gap is changed very little, and thereby it is possible to control the return loss very little.

Consequently, the optical attenuator 10 is provided at the optical fiber through which the light is transmitted, thereby it is possible to attenuate the quantity of light by the easy operation. Further, the return loss of the optical attenuator 10 is changed according to the distance of the gap at the optical contact portion B shown in FIG. 1B, thereby it is possible to control the return loss as the occasion may demand, by moving the ferrules 41. And further, the optical attenuator 10 has a simple structure, so that it is possible to provide the optical attenuator 10 at a low cost.

[Second embodiment of the invention]

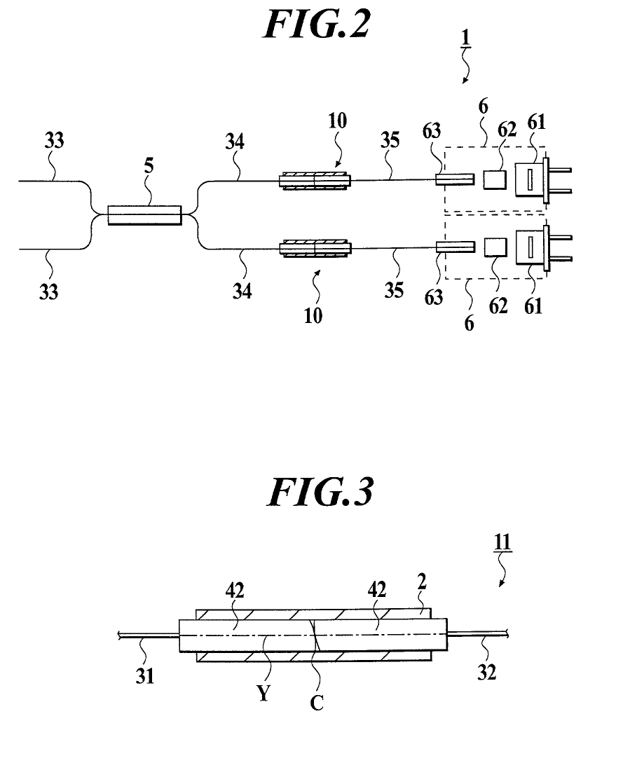

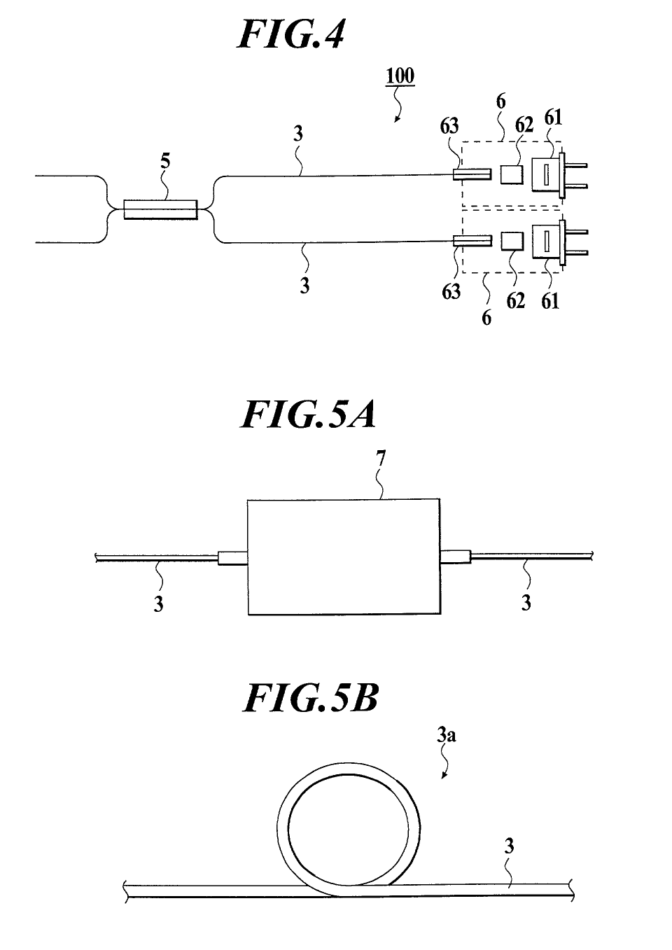

Next, as the second embodiment of the present invention, an optical photometer 1 to which the optical attenuator 10 as described above is adapted will be explained with reference to FIG. 2, as follows.

FIG. 2 is a view showing a schematic structure of the optical photometer 1. In FIG. 2, the reference numeral 33 denotes an input side optical fiber, the reference numeral 34 denotes a coupler output optical fiber, the reference numeral 35 denotes an attenuation output optical fiber, the reference numeral 5 denotes a coupler and the reference numeral 6 denotes a photo-reception module. According to the photo-reception module 6, the reference numeral 61 denotes a photo-reception element, the reference numeral 62 denotes a lens part and the reference numeral 63 denotes a ferrule.

The ferrule 63 is the same, for example, as the ferrule 41 of the optical attenuator 10 as described above. The input side optical fiber 33, the coupler output optical fiber 34 and the attenuation output optical fiber 35 are optical fiber used generally, and the same as the input side optical fiber 31 and the output side optical fiber 32 according to the first embodiment of the present invention. The optical attenuator 10 is the same as the optical attenuator 10 according to the first embodiment of the present invention and the explanation about the structure of the optical attenuator 10 will be omitted.

The optical photometer 1 shown in FIG. 2 comprises a double balanced receiver used in optical photometer apparatus of a heterodyne detection system.

The optical photometer 1 comprises an optical coupler 5, wherein two input side optical fibers 33 are connected to the input side of the optical coupler 5. According to each of two coupler output optical fibers 34, one edge portion thereof is connected to the output side of the optical coupler 5 and the other edge portion thereof is connected to one input side of two optical attenuators 10. According to each of two attenuation output optical fibers 35, one edge portion thereof is connected to one output side of the optical attenuators 10 and the other edge portion thereof is connected to one input side of the ferrules 63 of the photo-reception modules 6.

That is, one edge portion on each of two lines wherein the line is composed of the coupler output optical fiber 34, the optical attenuator 10 and the attenuation output optical fiber 35, is connected to the optical coupler 5. Further, the other edge portion on each line is connected to each photo-reception module 6.

The optical coupler 5 distributes the light inputted from the input side optical fibers 33 and outputs each light distributed to each of two coupler output optical fibers 34. Although the distribution ratio of the optical coupler 5 is equal, it is not limited that the distribution ratio including some errors is equal.

The light transmitted through the coupler output optical fiber 34 is inputted to the optical attenuator 10 and attenuated as described above. The light attenuated is inputted to the photo-reception module 6 through the attenuation output optical fiber 35.

The photo-reception module 6 comprises the photo-reception element 61, the lens part 62 and the ferrule 63. The ferrule 63 is connected to the attenuation output optical fiber 35. The photo-reception element 61 is such a device as a photo diode, a photo transistor and so on, for outputting a detection current according to the quantity of light received thereby.

The light inputted from the attenuation output optical fiber 35 to the ferrule 63 is condensed to a photo-reception surface of the photo-reception element 61 through the lens part 62. The photo-reception element 61 outputs the detection current according to the quantity of light received thereby.

Herein, according to the optical photometer 1, an example of a method for controlling the detection current outputted from two photo-reception modules 6 will be explained, as follows.

First, according to each optical attenuator 10, either or both ferrules 41 are moved so that the top surfaces of two ferrules 41 are contacted with each other. Next, the light to be controlled is inputted from the input side optical fibers 33 to the optical coupler 5, thereafter the detection currents outputted from two photo-reception elements 61 are detected.

Thereafter, when the deference between the detection currents outputted from two photo-reception elements 61 occurs, either or both ferrules 41 of the optical attenuator 10 connected to the photo-reception element 61 which has detected the bigger quantity of light, are moved along the optical axis.

As described above, the distance of the gap at the optical contact portion B shown in FIG. 1B is changed by moving the ferrules 41, thereby the return loss of the optical attenuator 10 is changed.

Therefore, according to the optical attenuator 10 connected to the photo-reception element 61 which has detected the bigger quantity of light, the ferrules 41 are moved so that the gap at the optical contact portion B becomes bigger, thereby the detection currents outputted from two photo-reception elements 61 is controlled. Accordingly, it is possible to make the detection currents equal to each other.

Consequently, it is possible to control the quantity of light of the optical photometer 1 by the easy operation. Further, it is possible to control the return loss of the optical photometer 1 at a very little level.

Further, the optical attenuator 10 has a simple structure so that it is possible to provide the optical attenuator 10 at a low cost. As a result, if the optical attenuator 10 is adapted to the optical photometer 1, it is possible to prevent the cost of the optical photometer 1 from increasing substantially.

Specially, when the optical attenuator 10 is adapted to such an apparatus having the double balanced receiver as the optical photometer 1, it is possible to easily control the dispersion of the characteristic of each component when the apparatus is manufactured. As a result, it is possible to reduce the number of manufacturing steps, to simplify the manufacturing steps and to reduce the manufacturing cost.

[Third embodiment of the invention]

Next, as the third embodiment of the present invention, an optical attenuator 11 will be explained with reference to FIG. 3, as follows.

FIG. 3 is a view showing a structure of the optical attenuator 11. In FIG. 3, the reference numeral 42 denotes a ferrule. The same reference numerals are attached to the same elements as the elements according to the first and second embodiments described above. Further, it is omitted that the same elements are explained.

As shown in FIG. 3, according to the optical attenuator 11, two angular polish ferrules 42 are held in the inside of the split sleeve 2.

The input side optical fiber 31 is connected to a base edge portion of one ferrule 42. The output side optical fiber 32 is connected to a base edge portion of the other ferrule 42. Two angular polish ferrules 42 are provided so that the top surfaces thereof are stood opposite to each other, and held in the same axis line in the inside of the sleeve 2.

Accordingly, cores of the input side optical fiber 31 and the output side optical fiber 32 agree with the optical axis of the angular polish ferrule 42, on the line shown by the reference character Y in FIG. 3.

The angular polish ferrule 42 is made of grass, resin, ceramics, zirconia or the like, like the ferrule 41 according to the first embodiment as described above.

The top portion of the angular polish ferrule 42 is polished so as to form a slant surface slanted against an optical axis in an inside of the angular polish ferrule 42. Although a top surface of a general ferrule as the ferrule 41 shown in FIG. 1A is formed so as to be vertical against the optical axis, the angular polish ferrule 42 has a top surface slanted against the optical axis at a predetermined angle.

That is, two angular polish ferrules 42 are contacted to each slant top surface thereof slanted against the line Y, at the optical contact portion shown by the reference character C in FIG. 3. Therefore, the reflection loss of the ferrule 42 is smaller than one of such a ferrule having the vertical top surface against the optical axis, for example, as the ferrule 41 shown in FIG. 1A. Accordingly, it is possible to generate the bigger return loss at the optical contact portion C than at the optical contact portion A shown in FIG. 1A.

Therefore, according to the optical contact portion C, the reflection light travels in an oblique direction against the line Y at the optical contact portion C, so that the reflection light returned to the input side optical fiber 31 is small. Accordingly, it is possible to reduce an interference and so on generated by returning the light to the apparatus connected to the input side optical fiber 31.

Consequently, according to the optical attenuator 11 as compared with the optical attenuator 10 according to the first embodiment as described above, it is possible to realize the bigger return loss and to control such an effect on the optical system as an interference and so on.

Further, according to the optical contact portion C, either or both angular polish ferrules 42 are moved along the optical axis, thereby the distance of the gap is changed. Therefore, the return loss is changed minutely. Accordingly, it is possible to control the return loss minutely. Further, the optical attenuator 11 has a very simple structure. Accordingly, it is possible to provide the optical attenuator 11 at a low cost.

Further, it is possible that the optical attenuator 11 is easily adapted to various types of apparatuses requiring attenuating the quantity of light, for example, as the optical photometer 1 according to the second embodiment as described above.

Although the present invention has been explained according to the above-described embodiment, it should also be understood that the present invention is not limited to the embodiment and various changes and modifications may be made to the invention without departing from the gist thereof.

For example, two ferrules 41 and two angular polish ferrules 42 are composed so as to be movable in the direction in which the top surfaces of ferrules 41 and the top surfaces of angular polish ferrules 42 are closed to each other or separated from each other, respectively. However, the present invention is not limited to the embodiment. Two ferrules 41 may have a structure in which either of ferrules 41 can be moved. The angular polish ferrules 42 may have a structure like the ferrules 41.

Further, the top surface of the ferrule 41 and the top surface of the angular polish ferrule 42 are not processed specially. However, the present invention is not limited to the embodiment. The top surfaces of the ferrule 41 and the angular polish ferrule 42 may be variously processed to change the reflection loss.

And further, the optical coupler 5 is composed so as to distribute the light to two coupler output optical fibers 34. However, the optical coupler 5 may be composed so as to distribute and to output the light to more many systems of optical fibers.

Further, the split sleeve 2 is made of resin, various types of metals, ceramics, zirconia or the like. The optical fiber as the input side optical fiber 31, the output side optical fiber 32, the input side optical fiber 33, the coupler output optical fiber 34, the attenuation output optical fiber 35 and so on are made of glass, resin or the like. The ferrule 41 and the angular polish ferrule 42 are made of glass, resin, ceramics, zirconia or the like. However, various changes and modifications may be made to the material of each part.

Further, the specific detail structure such as the angle between the top surface of the angular polish ferrule 42 and the optical axis and so on, may be changed and modified as the occasion may demand.

According to the present invention, a main effect can be obtained, as follows.

The gap is generated between the top surfaces of the ferrules, by moving the ferrules, and thereby the light is attenuated. Consequently, it is possible to attenuate a quantity of light by an easy operation. Further, a return loss of light is changed according to the distance of the gap generated between the ferrules. Consequently, it is possible to minutely control the return loss of light by changing the distance of the gap between the ferrules, as the occasion may demand. And further, the optical attenuator has a very simple structure, so that it is possible to provide the optical attenuator at a low cost.

The entire disclosure of Japanese Patent Application No. Tokugan 2000-20488 filed on Jan. 28, 2000 including specification, claims, drawings and summary are incorporated herein by reference in its entirety.

What is claimed is:

1. An optical attenuator comprising:
two ferrules provided so that top surfaces thereof are stood opposite to each other, in which an optical fiber is connected to a base edge portion on each of the ferrules and either or both of the ferrules can be moved along an optical axis of each ferrule; and
a split sleeve for holding the ferrules in the same axis line.

2. An optical attenuator according to claim 1,
wherein the top surface on each of the ferrules is formed so as to slant against the optical axis of each ferrule.

3. An optical photometer comprising:
an optical coupler for distributing a light inputted from an outside to a plurality of coupler output optical fibers, to output a distributed light to each of the coupler output optical fibers;
a plurality of optical attenuators connected to the optical coupler through the coupler output optical fibers respectively, in which each of the optical attenuators attenuates the distributed light by a predetermined return loss, to output an attenuated light to each of a plurality of attenuation output optical fibers; and
a plurality of detection members connected to the optical attenuators through the attenuation output optical fibers respectively, in which each of the detection members detects a quantity of the attenuated light;
wherein each of the optical attenuators comprises: two ferrules provided so that top surfaces thereof are stood opposite to each other, in which an optical fiber is connected to a base edge portion on each of the ferrules and either or both of the ferrules can be moved along an optical axis of each ferrule; and a split sleeve for holding the ferrules in the same axis line.

4. An optical photometer according to claim 3,
wherein the top surface on each of the ferrules is formed so as to slant against the optical axis of each ferrule.

5. An optical photometer according to claim 3,
wherein each of the detection members comprises: a ferrule to which the attenuated light is inputted from the attenuation output optical fiber; a lens part through which the attenuated light inputted to the ferrule is condensed; and a photo-reception element for outputting a detection current according to the attenuated light condensed through the lens part.

6. A method for controlling a quantity of light, by an optical attenuator, the optical attenuator comprising: two ferrules provided so that top surfaces thereof are stood opposite to each other, in which an optical fiber is connected to a base edge portion on each of the ferrules; and a split sleeve for holding the ferrules in the same axis line;
wherein the method comprises the step of moving either or both of the ferrules along an optical axis of each ferrule.
